(19) United States
(12) Patent Application Publication
(10) Pub. No.: US 2022/0199990 A1
(43) Pub. Date: Jun. 23, 2022

(54) LITHIUM TITANATE SINTERED BODY PLATE

(71) Applicant: NGK INSULATORS, LTD., Nagoya-City (JP)

(72) Inventors: Yukinobu YURA, Nagoya-City (JP); Shigeki OKADA, Nishio-City (JP)

(73) Assignee: NGK INSULATORS, LTD., Nagoya-City (JP)

(21) Appl. No.: 17/654,091

(22) Filed: Mar. 9, 2022

Related U.S. Application Data
(63) Continuation of application No. PCT/JP2020/033089, filed on Sep. 1, 2020.

(30) Foreign Application Priority Data
Nov. 20, 2019 (JP) 2019-209907

(51) Int. Cl. H01M 4/485; H01M 4/1391; H01M 4/131; H01M 10/052

(52) U.S. Cl. CPC H01M 4/485; H01M 4/1391; H01M 2004/027; H01M 10/052; H01M 4/131

(57) ABSTRACT

Provided is a lithium titanate sintered plate having a structure in which a plurality of primary grains are bound together. The lithium titanate sintered plate has a composition represented by the general formula Li₄(Ti_{5-α}M_{α})O_{12-δ}, wherein M is at least one selected from the group consisting of Nb, Ta, and W; α satisfies 0≤α≤2.5; and δ denotes oxygen-deficient amount, and may be 0, provided that α and δ are not 0 at the same time.

### CROSS-REFERENCE TO RELATED APPLICATIONS

This application is a continuation application of PCT/JP2020/033089 filed Sep. 1, 2020, which claims priority to Japanese Patent Application No. 2019-209907 filed Nov. 20, 2019, the entire contents all of which are incorporated herein by reference.

### BACKGROUND OF THE INVENTION

### 1. Field of the Invention

The present invention relates to a lithium titanate sintered plate to be used for the negative electrode of a lithium secondary battery.

### 2. Description of the Related Art

In recent years, lithium titanate Li₄Ti₅O₁₂ (hereinafter referred to as LTO) has been attracting attention as a negative electrode material for a lithium secondary battery (also called lithium-ion secondary battery). When LTO is used as a negative electrode material for a lithium secondary battery, there are advantages in that the volume change associated with lithium ion insertion/deinsertion is small, the cycle life and safety are superior to a carbon negative electrode, and the low temperature operability is superior.

It has also been proposed to sinter LTO to improve the energy density, etc. In other words, it has been proposed to use a LTO sintered body as the positive electrode or negative electrode of a lithium secondary battery. For example, Patent Literature 1 (JP5174283B) discloses a LTO sintered body, which has an average pore size of from 0.10 to 0.20 μm, a specific surface area of from 1.0 to 3.0 m²/g, and a relative density of from 80 to 90%, and contains crystal grains of titanium dioxide. Patent Literature 2 (JP2002-42785A) discloses a LTO sintered body, for which the filling ratio of an active material is from 50 to 80%, and the thickness is more than 20 μm but not more than 200 μm. Patent Literature 3 (JP2015-185337A) discloses a LTO sintered body, which has a relative density of 90% or more, and a particle size of 50 nm or more. Patent Literature 4 (JP6392493B) discloses a LTO sintered plate for which the thickness is from 10 to 290 μm, the primary grain size is 1.2 μm or less, the porosity is from 21 to 45%, the open porosity is 60% or more, the average pore aspect ratio is 1.15 or more, the proportion of pores with an aspect ratio of 1.30 or more with respect to the whole pores is 30% or more, the average pore size is 0.70 μm or less, and the D10 and D90 pore sizes satisfy 4.0≤D90/D10≤50.

In general, lithium titanate (LTO) has remarkably low electronic conductivity, and also lower ionic conductivity compared to lithium cobaltate which is widely used. Therefore, when a LTO powder is mixed with an ordinary binder or conductive assistant to prepare a coated electrode, a powder with small particle size is used. However, a negative electrode with such a constitution cannot exhibit adequate performance in the case of specifications aiming at high-speed charge and discharge and high-temperature operation while assuring high energy density as required for IoT applications. In contrast, the LTO sintered bodies as disclosed in Patent Literatures 1 to 4 can be superior in electronic conductivity, and suitable for high-temperature operation due to improvement in compactness by sintering.

### CITATION LIST

### Patent Literature

Patent Literature 1: JP5174283B
Patent Literature 2: JP2002-42785A
Patent Literature 3: JP2015-185337A
Patent Literature 4: JP6392493B

### SUMMARY OF THE INVENTION

It has been becoming clear that a lithium secondary battery using a LTO sintered plate as the negative electrode also has an advantage of a lower resistance value compared to a battery using a common LTO-coated electrode as the negative electrode. On the other hand, it has also come to know that the resistance of a battery using a LTO sintered plate is highly dependent on the change in its state of charge (SOC) and there is a problem that the resistance increases excessively when the SOC falls from a sufficiently charged state. For example, from 100% SOC to 30% SOC, the resistance may change 2.7 times. In contrast, in the case of a LTO coated electrode, the resistance does not show SOC dependence; however, there is a drawback in that the resistance is inherently high.

The inventors have now found that when a LTO sintered plate, in which part of Ti is substituted with another element such as Nb, and/or oxygen is made deficient, is incorporated into a lithium secondary battery as the negative electrode, the resistance at 100% SOC is low, and an excessive increase in the resistance can be suppressed even when the SOC falls (in other words, the resistance is low even at a low SOC).

Therefore, an object of the present invention is to provide a LTO sintered plate that has a low resistance even at a low SOC when incorporated into a lithium secondary battery as the negative electrode.

According to an aspect of the present invention, there is provided a lithium titanate sintered plate for use in a negative electrode of a lithium secondary battery, wherein the lithium titanate sintered plate has a structure in which a plurality of primary grains are bound together, and
wherein the lithium titanate sintered plate has a composition represented by the general formula Li₄(Ti_{5-α}M_{α})O_{12-δ}, wherein M is at least one selected from the group consisting of Nb, Ta, and W; α satisfies 0≤α≤2.5; and δ denotes oxygen-deficient amount, and may be 0, provided that α and δ are not 0 at the same time.

According to another aspect of the present invention, there is provided a lithium secondary battery comprising a positive electrode, a negative electrode including the lithium titanate sintered plate, and an electrolyte.

### DETAILED DESCRIPTION OF THE INVENTION

LTO Sintered Plate

The LTO sintered plate according to the present invention is used for the negative electrode of a lithium secondary battery. The LTO sintered plate has a structure in which a plurality of primary grains are bound together. Further, the LTO sintered plate has a composition represented by the general formula Li₄(Ti_{5-α}M_{α})O_{12-δ}, wherein M is at least one selected from the group consisting of Nb, Ta, and W; α satisfies 0≤α≤2.5; and δ denotes oxygen-deficient amount, and may be 0, provided that α and δ are not 0 at the same time. In the Formula, with respect to the basic composition of Li₄Ti₅O₁₂, part of Ti is substituted with an element M, or part of oxygen O is made deficient. When a LTO sintered plate, in which part of Ti is substituted with an element such as Nb, and/or made oxygen-deficient as above, is incorporated into a lithium secondary battery as the negative electrode, the resistance at 100% SOC is low, and an excessive increase in the resistance can be suppressed even when the SOC falls (in other words, the resistance is low even at a low SOC).

As described above, it has been becoming clear that a lithium secondary battery using a LTO sintered plate as the negative electrode has a lower resistance value compared to a battery using a common LTO-coated electrode as the negative electrode, however there is a problem that the resistance increases excessively when the SOC is lowered. This is presumably because a LTO sintered plate does not contain a binder nor a conductive assistant, so when a high resistance spot appears inside, there is no chance that a conductive assistant supplements the conductivity, and as a consequence, the resistance tends to rise excessively at a low SOC compared to a LTO coated electrode containing a conductive assistant. Such a problem can be favorably solved by using a LTO sintered plate in which part of Ti is substituted with an element such as Nb, and/or oxygen is made deficient. The mechanism thereof is not necessarily clear, but is presumed to be as follows. That is, it is presumable that the excessive increase in the resistance at a low SOC is caused by progression of two phase coexistence reaction of a high resistance spinel phase (Li₄Ti₅O₁₂; Ti is tetravalent) and a low resistance rocksalt phase (Li₇Ti₅O₁₂; Ti is 3.4-valent) accompanying charge and discharge. Further, it is presumable that the resistance increases due to increase in the proportion of the high resistance spinel phase (Li₄Ti₅O₁₂) at a low SOC. Against this problem, in the present invention, part of Ti in the spinel phase is presumably reduced from tetravalent to trivalent due to the measures that i) part of Ti is substituted with an element M (a 5-valent or 6-valent transition metal element such as Nb, Ta, and W having a valence higher than Ti), and/or ii) oxygen is made deficient, as represented by the general formula Li₄(Ti_{5-α}M_{α})O_{12-δ}. By doing so, it is presumable that the proportion of the low resistance rocksalt phase can be increased, and as a consequence the excessive increase in the resistance is suppressed even when the SOC is lowered, or in other words, the resistance can be kept low even at a low SOC.

For example, a lithium secondary battery using a LTO sintered plate of the present invention as the negative electrode, the R₃₀/R₁₀₀ which is the ratio of a resistance value R₃₀ at 1 Hz at 30% SOC where 30% of the battery capacity is charged to a resistance value R₁₀₀ at 1 Hz at 100% SOC where 100% of the battery capacity is charged, as evaluated by alternating current impedance measurements, is as low as less than 2.7, preferably from 1.0 to 2.5, more preferably from 1.02 to 2.0, further preferably from 1.05 to 1.7, and especially preferably from 1.1 to 2.0. As described above, since the resistance of a battery using a LTO sintered plate at 100% SOC is low (compared to a battery using a LCO coated electrode), a low R₃₀/R₁₀₀ means that the resistance is low even at a low SOC.

In the general formula Li₄(Ti_{5-α}M_{α})O_{12-δ} representing the composition of a LTO sintered plate, M may be at least one selected from the group consisting of Nb, Ta, and W. M preferably includes at least Nb, and is more preferably Nb. Nb and Ta are 5-valent elements, and W is a 6-valent element. It is presumable that by substitution with elements such as Nb, Ta, and W, which have a valence greater than that of Ti, part of Ti in the spinel phase is reduced from tetravalent to trivalent, and as a result, the proportion of the low resistance rocksalt phase can be increased, and consequently the resistance can be kept low even at a low SOC. The general formula satisfies 0≤α≤2.5, and preferably 0≤α≤2.5, more preferably 0.1≤α≤1.3, further preferably 0.2≤α≤1.2, and especially preferably 0.3≤α≤1.0. Within such a range, the above effect of element substitution can be attained more desirably.

The LTO sintered plate according to the present invention preferably has oxygen deficiency. In other words, δ in the general formula Li₄(Ti_{5-α}M_{α})O_{12-δ} is preferably not zero. In light of the current situation that it is not possible to determine quantitatively the amount of oxygen deficiency (δ) even with the latest equipment, the above general formula may be customarily abbreviated to Li₄(Ti_{5-α}M_{α})O₁₂. In any case, since the basic structure of LTO is maintained, it is typical that δ falls within the range of 0<δ<1 even when oxygen is deficient. It is presumable that by making oxygen deficient as above, part of Ti in the spinel phase is reduced from tetravalent to trivalent, and as a result, the proportion of the low resistance rocksalt phase can be increased, and consequently the resistance can be kept low even at a low SOC. A particularly preferable LTO sintered plate has oxygen deficiency and part of Ti is substituted with an element M (e.g., 0≤α≤2.5).

The thickness of a LTO sintered plate is from 10 to 1000 μm, preferably from 50 to 700 μm, and more preferably from 60 to 500 μm. The thicker the LTO sintered plate is, the easier it is to realize a battery with a high capacity and a high energy density. The thickness of a LTO sintered plate may be, for example, determined by observing a cross section of the LTO sintered plate with a SEM (Scanning Electron Microscope) and measuring the distance between the roughly parallel plate surfaces observed. The larger the thickness of the LTO sintered plate, the more likely the aforementioned effect can be obtained.

A LTO sintered plate contains pores. When a sintered plate contains pores, especially open pores, an electrolyte can be made penetrate into the inside of the sintered plate when incorporated into a battery as the negative electrode plate, and as a result the lithium ion conductivity can be improved. This is because, while there are two types of conduction of lithium ions in a sintered body: conduction through constituent grains of the sintered body; and conduction through an electrolyte in the pores, the conduction through an electrolyte in the pores is overwhelmingly faster.

The LTO sintered plate according to the present invention is used for the negative electrode of a lithium secondary battery. Therefore, according to a preferred aspect of the invention, a lithium secondary battery including a positive electrode, a negative electrode with the LTO sintered plate, and an electrolyte is provided. The positive electrode preferably includes a lithium composite oxide. Examples of the lithium composite oxide include lithium cobaltate, lithium nickelate, lithium manganate, lithium nickel manganate, lithium nickel cobaltate, lithium cobalt nickel manganate, and lithium cobalt manganate. The lithium composite oxide may include one or more elements selected from the group consisting of Mg, Al, Si, Ca, Ti, V, Cr, Fe, Cu, Zn, Ga, Ge, Sr, Y, Zr, Nb, Mo, Ag, Sn, Sb, Te, Ba, Bi, and W. The most preferable lithium composite oxide is lithium cobaltate (LiCoO₂). Therefore, a particularly preferable positive electrode is a sintered plate of a lithium composite oxide, and most preferably a sintered plate of lithium cobaltate. As the electrolyte, any known electrolyte that is commonly used for a lithium secondary battery may be used. In addition, the electrolyte may contain one or more selected from γ-butyrolactone, propylene carbonate, and ethylene carbonate at 96 vol % or more. By using such an electrolyte, a battery can be stably produced without degrading the battery at the time of production of the battery through a high temperature operation of the battery, and a high temperature process.

A lithium secondary battery produced using the LTO sintered plate of the present invention can be set in serial connection by simple control owing to high reliability such as excellent cycle performance and excellent storage performance (less self-discharge).

In addition, a lithium secondary battery using the LTO sintered plate of the present invention as the negative electrode is competent for constant voltage charge (CV charge) because dendrite is not generated. Charging may be performed by any of constant current charge (CC charge), constant current constant voltage (CC-CV charge), and CV charge. In a case where only CV charge is performed, since a charging IC is not required, there are advantages in that a battery can be operated with simple regulation, a battery can be made thin and small, etc.

When both the positive electrode and negative electrode are made of ceramics, a separator may also be made of ceramics and the three electrode components may be unified. For example, after fabricating a ceramic positive electrode, a ceramic negative electrode, and a ceramic separator, then these components may be unified by adhesion. Alternatively, before firing the ceramic components, three green sheets that bring about a positive electrode, a negative electrode, and a separator respectively, may be pressed together to form a laminate and then the laminate is fired to produce a unified ceramic component. Favorable examples of the constituent material for a ceramic separator include Al₂O₃, ZrO₂, MgO, SiC, and Si₃N₄.

When a battery, in which both the positive electrode and the negative electrode are ceramic plates, is produced, since the energy densities of both the electrode components are high, a thin battery can be produced. Since a thin battery is competent for CV charge as described above, it is particularly suitable for a smart card and a battery for IoT.

Production Method

The LTO sintered plate of the present invention may be produced by any method, but preferably it is produced through (a) production of a LTO-containing green sheet, and (b) firing of the LTO-containing green sheet. There is no particular restriction on their production conditions except for the following (i) and (ii), and known production methods (see, for example, Patent Literature 4) may be applied. The peculiar composition of the LTO sintered plate of the present invention can be realized by: (i) a compound of an element M is added at a step (a), and/or (ii) a treatment for generating oxygen-deficiency is carried out at a step (b).

(i) Addition of Compound of Element M

For obtaining a LTO sintered plate in which Ti is partially substituted with an element M, in preparing a LTO-containing green sheet (step (a)), a Li compound, and a compound of an element M (M is at least one selected from the group consisting of Nb, Ta, and W) are added to a LTO powder. Examples of the Li compound include Li₂CO₃, and Li(OH).H₂O. Examples of the Nb compound include Nb₂O₅, and Nb(OC₂H₅)₅. Examples of the Ta compound include Ta₂O₅, and Ta(OC₂H₅). Examples of the W compound include WO₃. The mixing ratio of the LTO powder, the Li compound, and the compound of an element M may be selected so that the composition of the LTO sintered plate to be obtained through firing a LTO containing green sheet meets Li₄(Ti_{5-α}M_{α})O_{12-δ}, wherein 0≤α≤2.5).

(ii) Treatment for Generating Oxygen-Deficiency

When oxygen-deficiency is to be generated in a LTO sintered plate, after firing of a LTO-containing green sheet (step (b)), the resulting LTO sintered plate is heat-treated under an atmosphere containing a reducing gas. Examples of the reducing gas include hydrogen. The atmosphere containing a reducing gas is preferably a blend gas of Ar and H₂, and the mole fraction of H₂ in an Ar+H₂ gas is preferably from 1 to 20%. The heat treatment conditions may be determined as appropriate so as to obtain desired oxygen-deficiency, and the heat treatment should preferably be carried out at from 500 to 900° C. for from 5 to 300 min. By such a heat treatment, desired oxygen-deficiency may be generated in the LTO sintered plate.

For better understanding of the production method of the present invention, a conventional method for producing a LTO sintered plate not including the (i) and (ii) above (that is, steps (a) and (b)) are added below for reference.

(a) Production of LTO Containing Green Sheet

First, a raw material powder (LTO powder) composed of lithium titanate Li₄Ti₅O₁₂ is provided. As the raw material powder, a LTO powder may be a commercially available product, or newly synthesized. For example, a powder obtained by hydrolyzing a mixture of titanium tetraisopropoxy alcohol and isopropoxylithium may be used, or a mixture containing lithium carbonate, titania, etc. may be fired. The volume-based D50 particle size of a raw material powder is preferably from 0.05 to 5.0 μm, and more preferably from 0.1 to 2.0 μm. When the particle size of a raw material powder is larger, the pore size tends to become larger. When the particle size of the raw material powder is large, a grinding treatment (such as pot mill grinding, bead mill grinding, and jet mill grinding) may be carried out so as to realize a desired particle size. Then, the raw material powder is mixed with a dispersion medium and various additives (binder, plasticizer, dispersant, etc.) to form a slurry. Into the slurry, a lithium compound (such as lithium carbonate) other than LiMO₂ may be added in an excess of about 0.5 to 30 mol % for the purpose of promoting grain growth or compensating for volatile components in the firing step described below. It is desirable that a pore-forming material is not added to the slurry. It is preferable that the slurry is stirred under reduced pressure to defoam, and the viscosity is adjusted to 4000 to 10000 cP. The resulting slurry is shaped into a sheet form to obtain a LTO-containing green sheet. A thus obtained green sheet is an independent sheet-form green body. An independent sheet (occasionally referred to as “self-supported film”) means a sheet that can be handled alone (including a thin piece with an aspect ratio of 5 or more) independently of another support. In other words, an independent sheet does not include a sheet that is fixed to a support (such as a substrate) and integrated with the support (cannot be separated, or is difficult to be separated). Sheet forming may be done by various well-known methods, but is preferably done by the doctor blade method. The thickness of a LTO-containing green sheet may be set appropriately such that the desired thickness as described above can be achieved after firing.

(b) Firing of LTO-Containing Green Sheet.

A LTO-containing green sheet is placed on a setter. The setter is made of ceramics, preferably of zirconia or magnesia. The setter is preferably embossed. The green sheet placed on the setter is then housed in a sheath. The sheath is also made of ceramics, preferably of alumina. Then, in this state, if necessary after degreasing, it is fired to yield a LTO sintered plate. The firing should preferably be carried out in a range of 600 to 900° C. for 1 to 50 hours, and more preferably in a range of 700 to 800° C. for 3 to 20 hours. The thus obtained sintered plate is also in a form of an independent sheet. The rate of temperature increase at the time of firing is preferably from 100 to 1000° C./hour, and more preferably from 100 to 600° C./hour. In particular, it is preferable that this rate of temperature increase is employed in a temperature elevation step from 300° C. to 800° C., and more preferably in a temperature elevation step from 400° C. to 800° C. process.

### EXAMPLES

The invention will be described more specifically by way of the following Examples.

### Example 1 (Comparison)

(1) Production of Negative Electrode Plate

(1a) Production of LTO Green Sheet

First, 100 parts by weight of a LTO powder (volume-based D50 particle size 0.6 μm, manufactured by Ishihara Sangyo Kaisha, Ltd.), 100 parts by weight of a dispersion medium (toluene/isopropanol=1/1), 20 parts by weight of a binder (poly(vinyl butyral): grade number BM-2, manufactured by Sekisui Chemical Co., Ltd.), 4 parts by weight of a plasticizer (DOP: di(2-ethylhexyl) phthalate, manufactured by Kurogane Kasei & Co. Ltd.), and 2 parts by weight of a dispersant (product name: Leodol SP-O30, manufactured by Kao Corporation) were mixed. The resulting negative electrode raw material mixture was stirred under reduced pressure to defoam, and the viscosity was adjusted to 4000 cP to prepare a LTO slurry. The viscosity was measured with a LVT type viscometer manufactured by Brookfield. The thus prepared slurry was shaped into a sheet on a PET film by the doctor blade method to prepare a LTO green sheet. The thickness of the LTO green sheet after drying was adjusted such that the thickness after firing became 100 μm.

(1 b) Production of LTO Sintered Plate

The obtained green sheet was cut into a 25 mm square piece with a utility knife and placed on a magnesia-made setter. The green sheet on the setter was housed in an alumina-made sheath, held at 500° C. for 5 hours, then heated at a rate of temperature increase of 200° C./hour, and fired at 800° C. for 5 hours. On a surface in contact with the setter of the obtained LTO sintered plate, an Au film (thickness: 100 nm) was formed by sputtering as the current collector layer, which was then laser-processed to a circular shape with a diameter of 10 mm.

(2) Production of Positive Electrode Plate

(2a) Production of LiCoO₂ Green Sheet

First, a Co₃O₄ powder (manufactured by Seido Chemical Industry Co., Ltd.) and a Li₂CO₃ powder (manufactured by The Honjo Chemical Corporation) were weighed such that the molar ratio of Li/Co became 1.02. These powders were mixed and held at 750° C. for 5 hours. The resulting powder was ground in a pot mill to a volume-based D50 particle size of 0.4 μm to yield a LiCoO₂ powder. Then 100 parts by weight of the LiCoO₂ powder, 100 parts by weight of a dispersion medium (toluene/isopropanol=1/1), 10 parts by weight of a binder (poly(vinyl butyral): grade No. BM-2, manufactured by Sekisui Chemical Co., Ltd.), 4 parts by weight of a plasticizer (DOP: di(2-ethylhexyl) phthalate, manufactured by Kurogane Kasei & Co. Ltd.), and 2 parts by weight of a dispersant (product name: Leodol SP-O30, manufactured by Kao Corporation) were mixed. The resulting mixture was stirred under reduced pressure to defoam, and the viscosity was adjusted to 4000 cP to prepare a LiCoO₂ slurry. The viscosity was measured with a LVT type viscometer manufactured by Brookfield. The thus prepared slurry was shaped into a sheet on a PET film by the doctor blade method to prepare a LiCoO₂ green sheet. The thickness of the LiCoO₂ green sheet was 80 μm in terms of the thickness after drying.

(2b) Production of LiCoO₂ Sintered Plate

The LiCoO₂ green sheet peeled off from the PET film was cut into a 25 mm square piece with a utility knife and placed on a magnesia-made setter. The green sheet on the setter was housed in an alumina-made sheath, held at 500° C. for 5 hours, then heated at a rate of temperature increase of 200° C./hour, and fired at 800° C. for 5 hours. On a surface in contact with the setter of the thus obtained LiCoO₂ sintered plate, an Au film (thickness: 100 nm) was formed by sputtering as the current collector layer, which was then laser-processed to a circular shape with a diameter of 11 mm.

(3) Production of Battery

A LiCoO₂ sintered plate (positive electrode plate), a separator, and a LTO sintered plate (negative electrode plate) were stacked one by one to form a layered body. By immersing this layered body in an electrolyte, a coin type battery was produced. As the electrolyte, there was used a liquid prepared by dissolving LiBF₄ in an organic solvent of propylene carbonate (PC) and γ-butyrolactone (GBL) mixed in a volume ratio of 1/3, at a concentration of 1.5 mol/L. As the separator, a 25 μm-thick cellulose porous monolayer membrane (manufactured by Nippon Kodoshi Corporation) was used.

### Example 2

A negative electrode plate, a positive electrode plate, and a battery were produced in the same manner as in Example 1 except that a heat treatment at 800° C. for 5 min in an atmosphere of Ar/H₂=96 vol %/4 vol % was performed on the LTO sintered plate in the (1 b) above.

### Example 3

A negative electrode plate, a positive electrode plate, and a battery were produced in the same manner as in Example 1 except that a Li₂CO₃ powder (manufactured by The Honjo Chemical Corporation) and a Nb₂O₅ powder (manufactured by Mitsui Mining & Smelting Co., Ltd.) were mixed with a LTO powder such that the composition of a LTO sintered plate became Li₄Ti_{4.75}Nb_{0.25}O₁₂ in the (1a) above.

### Example 4

A negative electrode plate, a positive electrode plate, and a battery were produced in the same manner as in Example 1 except i) that a Li₂CO₃ powder (manufactured by The Honjo Chemical Corporation) and a Nb₂O₅ powder (manufactured by Mitsui Mining & Smelting Co., Ltd.) were mixed with a LTO powder such that the composition of a LTO sintered plate became Li₄Ti_{4.75}Nb_{0.25}O₁₂ in the (1a) above, and ii) that a heat treatment at 800° C. for 5 min in an atmosphere of Ar/H₂=96 vol %/4 vol % was performed on the LTO sintered plate in the (1b) above.

### Example 5 (Comparison)

A battery was produced in the same manner as in Example 1 except that a coated electrode (manufactured by Hachiyama Co., Ltd.) configured with a negative electrode active material (material: LTO), a binder, and a conductive assistant was used in place of the LTO sintered plate as the negative electrode plate, and that a coated electrode (manufactured by Hachiyama Co., Ltd.) configured with a positive electrode active material (material: LiCoO₂), a binder, and a conductive assistant was used in place of the LiCoO₂ sintered plate as the positive electrode.

Evaluation

The following various evaluations were conducted on the negative electrodes (LTO sintered plate or coated electrode) and the coin type battery obtained in Examples 1 to 5.

<Oxygen-Deficiency>

Oxygen-deficiency was determined to be positive: i) if the color of a LTO sintered plate obtained in Examples 1 to 4 was not white (blue) when compared with the Standard Paint Colors of Japan Paint Manufacturers Association, and ii) if, when an XRD measurement was performed in a range of 2θ=20 to 70° and the maximum intensity of the peak attributed to LTO was taken as 100, the maximum intensity of any of other peaks (such as Li₂TiO₃) was 5 or less. The results were as shown in Table 1. In a case in which oxygen is deficient, the value of δ in the general formula Li₄(Ti_{5-α}M_{α})O_{12-δ} is construed to be in a range of 0<δ<1.

<Battery Capacity/SOC State>

With respect to the obtained coin battery, constant current charge (CC charge) was performed at 0.05 C up to 2.7 V, and then constant current discharge (CC discharge) was performed at 0.05 C. This operation cycle was repeated 3 times. The average of the obtained discharge capacities was taken as the battery capacity. A state in which 100% of the obtained battery capacity is charged is herein referred to as 100% SOC, and a state in which 30% is charged is referred to as 30% SOC.

<Battery Resistance>

By alternating current impedance measurements, a resistance value R₁₀₀ of a coin type battery at 1 Hz at 100% SOC, and a resistance value R₃₀ of the coin type battery at 1 Hz at 30% SOC were measured. The relative value of the resistance at 100% SOC of each Example was calculated with respect to the resistance at 100% SOC in Example 1 as 100. Further, the resistance ratio (R₃₀/R₁₀₀) was calculated by dividing the resistance value R₃₀ by the resistance value R₁₀₀. The results were as shown in Table 1.

TABLE 1
Table 1

| | Positive | | | | | |
|---|---|---|---|---|---|---|
| | electrode | Negative electrode | | | Battery resistance | |
| | and negative | Amount of | | | Resistance at | |
| | electrode | Nb | | | 100% SOC | Resistance |
| | Type of | substitution | α in | Oxygen- | (relative | ratio |
| | electrode | (mol %) | Li₄(T_{5-α}M_{α})O₁₂₋₅ | deficient | value) | (R₃₀/R₁₀₀) |
| Example 1* | Sintered plate | 0 | 0 | No | 100 | 2.7 |
| Example 2 | Sintered plate | 0 | 0 | Yes | 95 | 2.0 |
| Example 3 | Sintered plate | 5 | 0.25 | No | 95 | 1.7 |
| Example 4 | Sintered plate | 5 | 0.25 | Yes | 90 | 1.5 |
| Example 5* | Coated electrode | 0 | 0 | — | 400 | 1.2 |

*represents comparative example.

What is claimed is:

1. A lithium titanate sintered plate for use in a negative electrode of a lithium secondary battery, wherein the lithium titanate sintered plate has a structure in which a plurality of primary grains are bound together, and
wherein the lithium titanate sintered plate has a composition represented by the general formula Li₄(Ti_{5-α}M_{α})O_{12-δ}, wherein M is at least one selected from the group consisting of Nb, Ta, and W; α satisfies 0≤α≤2.5; and δ denotes oxygen-deficient amount, and may be 0, provided that α and δ are not 0 at the same time.

2. The lithium titanate sintered plate according to claim 1, wherein the M comprises at least Nb.

3. The lithium titanate sintered plate according to claim 2, wherein the M is Nb.

4. The lithium titanate sintered plate according to claim 1, wherein the general formula satisfies 0.1≤α≤1.3.

5. The lithium titanate sintered plate according to claim 1, which is oxygen deficient, or has δ of non-zero.

6. A lithium secondary battery comprising a positive electrode, a negative electrode including the lithium titanate sintered plate according to claim 1, and an electrolyte.

7. The lithium secondary battery according to claim 6, wherein R₃₀/R₁₀₀ is from 1.0 to 2.5, wherein R₃₀/R₁₀₀ is a ratio of a resistance value R₃₀ at 1 Hz at 30% SOC to a resistance value R₁₀₀ at 1 Hz at 100% SOC as evaluated by alternating current impedance measurements, 30% SOC indicating that 30% of the battery capacity is charged, and 100% SOC indicating that 100% of the battery capacity is charged.
